(19) United States
(12) Patent Application Publication
(10) Pub. No.: US 2026/0090931 A1
(43) Pub. Date: Apr. 2, 2026

(54) DIAPERING AND DRESSING DEVICE

(71) Applicant: Michael Berman, Afula (IL)

(72) Inventor: Michael Berman, Afula (IL)

(21) Appl. No.: 18/901,183

(22) Filed: Sep. 30, 2024

(51) Int. Cl. A61G 5/10

(52) U.S. Cl. CPC A61G 5/1056; A61G 5/1091; A61G 2200/34

(57) ABSTRACT

A diapering/dressing device configured to aid in removing a dirty diaper or underpants and trousers of a user sitting on a seat of a wheelchair and to aid in dressing a new diaper or trousers on the user. The device includes a plurality of wheelchair seat cushions; a rigid seat cushion support configured to support the plurality of wheelchair seat cushions; and a cushion movement mechanism, wherein the rigid seat cushion support is bowed to correspond to the curvature of the seat of the wheelchair.

### FIELD OF THE INVENTION

The present invention relates to patient care devices, in particular a portable device to aid in diapering and/or dressing a person with limited self-mobility.

### BACKGROUND OF THE INVENTION

For people confined to a wheelchair, changing clothes and, when required, changing diapers, can be a challenging experience, for them and/or for their care-givers. In addition, pressure sores may also result from long periods of sitting.

U.S. Pat. No. 4,207,633 (Imel et al.) relates to an inflatable body support to facilitate bedpan use or treatment of pelvic or anal areas of a person confined to a hospital bed or a wheelchair.

US 2004/222611 (Fenwick et al.) discloses a reclining and tilting wheelchair with a seat and back support cushion having a plurality of matrices of air cell capable of being individually programmed to inflate and deflate.

### SUMMARY OF THE INVENTION

The present invention relates to a portable patient care device to aid in diapering and/or dressing a person in a wheelchair. The diapering/dressing device is particularly useful for geriatric patients, handicapped people or anyone with mobility or incontinence issues.

The present invention provides a portable diapering/dressing device that facilities the dressing of a person, and to facilitate diapering, and is configured to facilitate cleaning and/or drying a person after removal of a diaper. The device is in a form of a seating surface including a number of specifically located separate cushions and a rigid cushion support; and in some examples, at least some of the cushions are specially shaped. The device is particularly suitable for placement on a wheel chair, in correspondence with which the cushion support can be made, to suit the curvature of the seat of the wheelchair.

According to examples of the present invention, there is provided a diapering/dressing device configured to aid in removing a dirty diaper or underpants and trousers of a user sitting on a seat of a wheelchair and to aid in dressing a new diaper or trousers on the user, The device includes: (a) a plurality of inflatable and deflatable wheelchair seat cushions; (b) a bowed rigid seat cushion support configured to support the plurality of inflatable and deflatable wheelchair seat cushions, the bowed rigid seat cushion support being bowed to correspond to the curvature of the seat of the wheelchair; and (c) an inflator/deflator.

In some examples, the plurality of inflatable and deflatable wheelchair seat cushions includes a front and rear cushion on the right side of the device; a middle cushion extending from the front to the rear of the device; and a front and rear cushion on the left side of the device.

In some examples, the front cushion and the rear cushion on the right side of the device are in the shape of trapeziums; and the front cushion and the rear cushion on the left side of the device, are in the shape of trapeziums.

In some examples, the device further includes at least one backrest cushion. In some examples, the device further includes a controller programmable to control the inflation and deflation of the seat cushions. In some examples, the device further includes a controller programmable to control the inflation and deflation of the backrest cushion. In some examples, the device further includes straps or flaps or a pocket configured to hold bowed rigid seat cushion support to the seat cushions.

The present device is efficacious in preventing pressure sores by inflating and deflating the cushions cyclically, causing prevention of vascular disorder in the blood vessels in the buttocks. The device also obviates the patient to need to raise himself/herself in order to be conveniently diapered or dressed, or requiring a caregiver to lift the patient.

The present device can also be used as a lifting support to help raise a patient out of the wheelchair, with the help of lifting straps and lifting handles in the sides and/or corners of rigid seat support.

### BRIEF DESCRIPTION OF THE DRAWINGS

The present invention will be understood and appreciated more fully from the following detailed description taken in conjunction with the appended drawings in which:

FIG. 1 is an exploded perspective view of a diapering and dressing device in accordance with the present subject matter.

FIGS. 2A and 2B are straight on views from the rear, respectively, comparing a known cushion device and the present device, resting on a wheelchair.

FIGS. 3A-3C are perspective views, respectively, of examples of the present device illustrating exemplary connection designs for connecting cushion supports of the device to a rigid bowed seat cushion support thereof.

FIGS. 4A-4C are an exploded perspective view; a non-exploded perspective view; and a detailed perspective view of a portion of FIGS. 4A and 4B, of another example of the diapering and dressing device, in accordance with the present subject matter.

The following detailed description of examples of the invention refers to the accompanying drawing(s) referred to above. Dimensions of components and features shown in the figure(s) are chosen for convenience or clarity of presentation and are not necessarily shown to scale. Wherever possible, the same reference numbers will be used throughout the drawing(s) and the following description to refer to the same and like parts.

### DESCRIPTION OF EXAMPLES

Illustrative examples of the invention are described below. In the interest of clarity, not all features/components of an actual implementation are necessarily described. Examples featured in the figure(s) are chosen for convenience or clarity of presentation and are not meant to limit the scope of the invention.

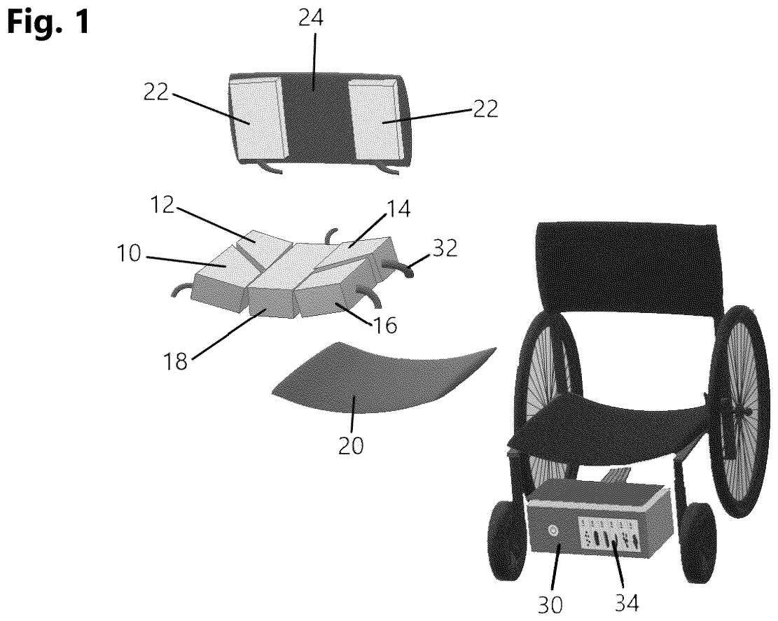

FIG. 1 shows an example of the present diapering/dressing device, which can be particularly suited for use with a wheelchair, and is described in that context. The device is in a form of a seating surface including a series of seat cushions, for example seat cushions 10, 12, 14, 16, and 18 supported by a rigid bowed seat cushion support 20. In particular examples rigid bowed seat cushion support 20 is configured to correspond to the bowed seat of wheelchairs. The device may optionally include one or more backrest cushions 22. Backrest cushions 22 may be attached directly to the back of the wheel chair, allowing for convenient folding of the wheelchair; or alternatively, supported by a rigid bowed back cushion support 24—or by a non-rigid support, which would also allow for convenient folding of the wheelchair.

Seat cushions 10 and 12 are respectively located at the front and rear of the left side above rigid bowed seat cushion support 20, as one faces the wheelchair. Seat cushions 14 and 16 are respectively located at the rear and front of the right side above rigid bowed seat cushion support 20, as one faces the wheelchair. Seat cushion 18 is located at the middle portion above rigid bowed seat cushion support 20, extending from the front to the rear.

The device also includes a cushion inflator/deflator 30 (aka compressor) pneumatically connected, for example by hoses 32, to each of the cushions 10, 12, 14, 16, 18, and 22. Cushion inflator/deflator 30, illustrated as supported by a wheelchair, can be operated manually, or preferably via a controller 34 that is configured to allow controlling the sequence of inflation and deflation operations of the cushions—for diapering; dressing; and potentially for preventing pressure sores, and which by a hand-held controller.

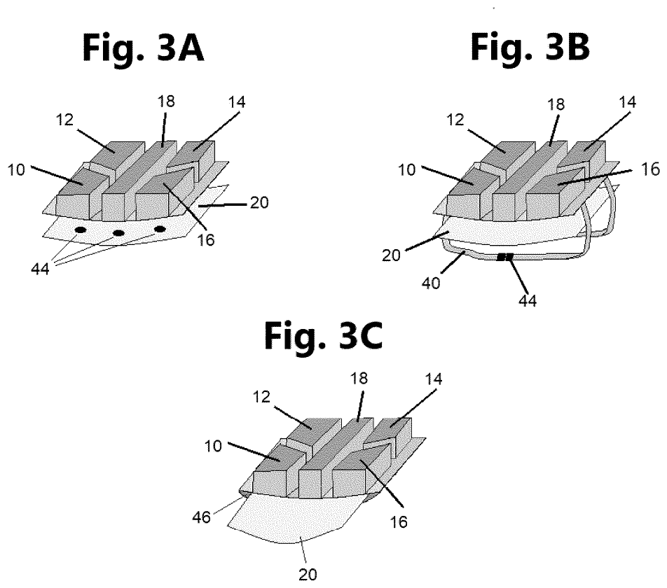

In some examples, seat cushions 10, 12, 14, 16, and 18 are directly attached to rigid bowed seat cushion support 20, for example via an adhesive. Alternatively, seat cushions 10, 12, 14, 16, and 18 are attached to rigid bowed seat cushion support 20, for example, via straps 40 or a flap 42 with connector clips 44; or via a flexible pocket 46 that can be attached to the cushions wherein the pocket is configured so that the rigid bowed seat cushion support is receivable therein (FIGS. 3A-3C, respectively).

In some examples, seat cushions 10, 12, 14, and 16 (the cushions located above the left and right sides of rigid bowed seat cushion support 20), are shaped in the form of three-dimensional right-angled trapeziums. The right-angled trapezium shape of the seat cushions can be helpful as they can be angled at an angle corresponding to the front lower portion of the diaper when it is worn, so that when cushion 12 or 14 is not inflated, cushions 10 and 16 (respectively) will still be able to maximally support the patient's mass thanks to the prominent/pointy side thereof, without interfering with the removal of the diaper. Seat cushion 18 is typically shaped in the form of a rectangle and located above the middle of rigid bowed seat cushion support 20.

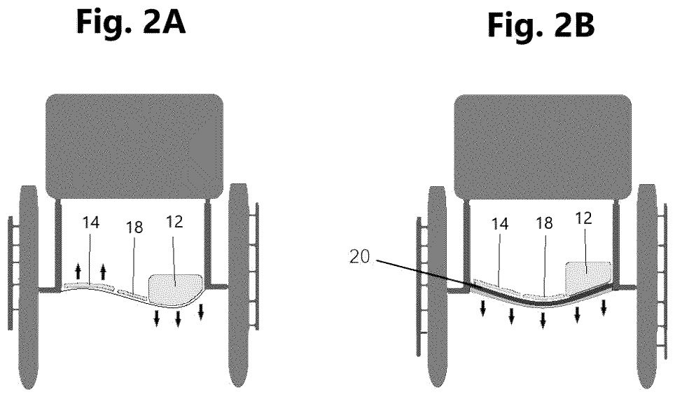

FIGS. 2A and 2B illustrate the special advantage of rigid bowed seat cushion support 20, in conjunction with seat cushions 10, 12, 14, 16, and 18—the view is shown from the rear. As seen in FIG. 2A, without rigid bowed seat cushion support 20, the wheelchair seat allows an inflated cushion (e.g. cushion 12) to press downward due to the weight of the patient; and at the same time the uninflated cushions (e.g. cushions 10, 14, and 18, of which 14 and 18 are visible from this view) will be pushed upward. As such, the difference in the level of the patient may not be great enough to conveniently dress/undress or diaper and remove a diaper of the patient. In contrast, FIG. 2B illustrates that a significantly convenient height difference in the level of the patient can be maintained due to the support provided by rigid bowed seat cushion support 20, so as to ease dressing/diapering.

In one example, to help enable the roll up of the patient's trousers, cushions 12 and 18 are deflated; and backrest cushions 22 are inflated in order to support the patient. Then, the upper right part of the pants/trousers can be rolled half way of the wheelchair's seat. Then, seat cushion 12 is inflated, and seat cushion 14 is deflated, to enable the roll up of the upper left part of the trousers also half way of the wheelchair's seat. Then, seat cushion 14 is inflated and seat cushion 16 is deflated, in order to allow the left portion of the trousers to be rolled up completely. Finally, seat cushion 16 is inflated and seat cushion 10 is deflated in order to allow the right part of the trousers to be rolled up completely. Then, seat cushions 10 and 18 are inflated. The trousers can be dressed on the patient in the reverse sequence as just described.

In another example, to remove a patient's diaper, seat cushion 18 is deflated to form a recess. Then, right backrest cushion 22 is inflated to support the patient and rear-left seat cushion 12 is deflated so that the right side of a dirty diaper can be rolled into the recess. Then, cushion 12 is inflated and right backrest cushion 22 is deflated. Then, left backrest cushion 22 is inflated and rear-left seat cushion 14 is deflated so that the left side of the dirty diaper can be rolled into the recess. Then, left backrest cushion 22 is deflated and left-rear seat cushion 14 is inflated. The dirty diaper is then rolled into the resultant recess, and is removed rearwardly, under the patient.

While cushion 18 is still lowered, the user's buttocks can be cleaned by wiping with a hygienic towelette or the like. A new diaper can be placed in the recess under the patient and dressed on the patient in the reverse sequence to that described above.

In another example, the device can be used to help prevent pressure sores by inflating and deflating alternately cushions 12, 14 and 18 cyclically.

In another example, the diapering/dressing device is configured as an integral portion of the seat of the wheelchair.

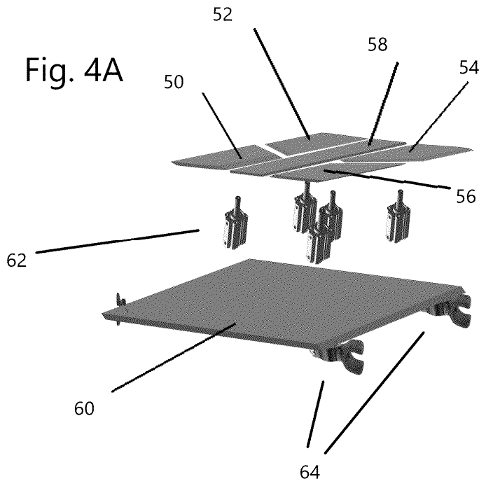

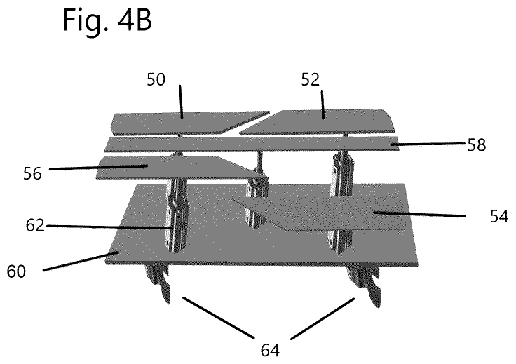

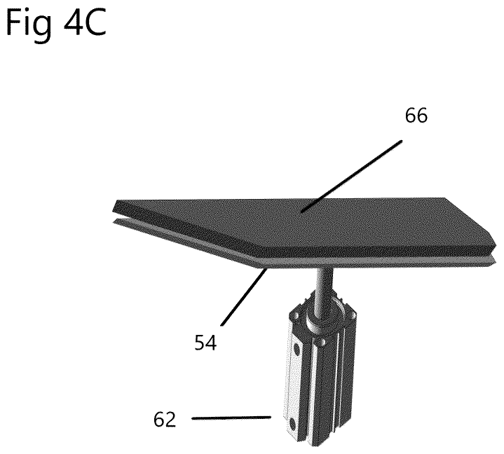

FIGS. 4A-4C show another example of the diapering and dressing device in accordance with the present subject matter. In this example, there is a movement mechanism 62 (illustrated by pistons 62); the cushion support is a flat support 60; and each of the seat cushions include a rigid plate 50, 52, 54, 56 and 58, with a cushion 66 (FIG. 4C) on each—e.g. glued to the plates. Pistons 62 can be pneumatic, hydraulic, electric motors, or any mechanism capable of adjusting the position (height) of the rigid plates 50, 52, 54, 56 and 58. Cushions 66 may include foam, or generally soft material.

The movement mechanism 62 is configured to elevate and lower (or extend outward and downward) any of the rigid plates 50, 52, 54, 56 and 58. The flat support 60 may be connected directly to the wheelchair via connectors 64, or the support may sit on top of the wheel chair's seat. Analogously, 20 rigid bowed seat cushion support 20 could similarly be attached directly to the wheel chair.

This movement mechanism 62 may provide greater vertical movement/clearance, which can ease the diapering and/or dressing process can be more convenient; and provide more back movement options for the patient.

It should be understood that the device can be modified to be designed for an infant. It can be similar in design to the examples described above, but smaller, for example, whereby the device can be placed on a dresser or counter-top. The smaller size can allow foldability.

It should also be understood that the above description is merely exemplary and that there are various examples of the present invention that may be devised, mutatis mutandis, and that the features described herein, and those not described herein, may be used separately or in any suitable combination; and the invention can be devised in accordance with examples not necessarily described above.

1. A diapering/dressing device configured to aid in removing a dirty diaper or underpants and trousers of a user sitting on a seat of a wheelchair and to aid in dressing a new diaper or trousers on the user, the device comprising:
a plurality of wheelchair seat cushions;
a rigid seat cushion support configured to support the plurality of wheelchair seat cushions; and
a cushion movement mechanism,
wherein the rigid seat cushion support is bowed to correspond to the curvature of the seat of the wheelchair.

2. The device according to claim 1, wherein the seat cushions are inflatable and deflatable.

3. The device according to claim 1, wherein the seat cushions comprise a rigid plate and a seat cushion thereon.

4. The device according to claim 1, wherein the seat cushions include foam.

5. The device according to claim 1, wherein the device includes a lifting support to help raise a patient out of the wheelchair.

6. The device according to claim 1, wherein the cushion movement mechanism comprises pistons.

7. The device according to claim 1, wherein the cushion movement mechanism comprises an inflator/deflator.

8. The device according to claim 1, wherein the plurality of wheelchair seat cushions comprises a front and rear cushion on the right side of the device; a middle cushion extending from the front to the rear of the device; and a front and rear cushion on the left side of the device.

9. The device according to claim 8, wherein the front cushion and the rear cushion on the right side of the device are in the shape of trapeziums;
and the front cushion and the rear cushion on the left side of the device, are in the shape of trapeziums.

10. The device according to claim 1, further including at least one backrest cushion.

11. The device according to claim 1, further including a controller programmable to control the cushion movement mechanism.

12. The device according to claim 1, further including any of straps or flaps or a pocket configured to hold the rigid seat cushion support to the seat cushions.
